(19) United States
(12) Patent Application Publication
(10) Pub. No.: US 2002/0129359 A1
(43) Pub. Date: Sep. 12, 2002

(54) Cross platform system and method for the management and distribution of pay per view video on demand

(76) Inventor: Randall Manton Lichner, Manhattan Beach, CA (US)

Correspondence Address: Randall Lichner, Post Office Box 3723, Manhattan Beach, CA, 90266, US

(21) Appl. No.: 10/003,493

(22) Filed: Nov. 20, 2001

Related U.S. Application Data
(60) Provisional application No. 60/253,210, filed on Nov. 27, 2000.

(51) Int. Cl. H04N 7/16

(52) U.S. Cl. 725/5; 725/25

(57) ABSTRACT

A cross platform system and method for distributing multimedia in accordance with seller determined properties that includes the establishment by a customer of an account with the seller which includes detailed billing information, the assignment of a customer identification number to the account maintained by the customer, detailed customer account history and automated credit card processing of customer authorized media purchases, using a client-based Internet browser as the point of sale device and multimedia stream receiver evocative of conventional pay per view television.

| Inventor: | Lichner, Randall M. (Manhattan Beach, CA) |
|---|---|
| Correspondence | Post Office Box 3723 |
| Address: | Manhattan Beach |
| | CA |
| | 90266 |
| | US |
| U.S. Current Class: | 725/5, 11, 25, 29, 30, 34, 37, 87, 104 |

### REFERENCES CITED

### U.S. PATENT DOCUMENTS

| | | | |
|---|---|---|---|
| 6,067,416 | 06/1997 | Frazier | 717/11; 705/26; 705/51; 705/58 |
| 5,671,225 | 09/1997 | Hooper, et al. | 370/468; 348/12 |
| 5,838,906 | 11/98 | Doyle, et al | 709/202; 345/738; 345/804; |
| | | | 707/513; 707/515; 707/516; |
| | | | 709/218; 709/315 |
| 5,970,470 | 10/1999 | Walker, et al. | 705/14; 705/20 |
| 6,061,720 | 05/2000 | Kamel, et al. | 709/219 |

### U.S. PATENT APPLICATIONS

| | | | |
|---|---|---|---|
| 60/253,210 | 11/2000 | Lichner | 725/5, 11, 25, 29, 30, 34, 37, 87, 104 |

### BACKGROUND AND SUMMARY OF THE INVENTION

The subject matter of this application is generally related to that disclosed in the references cited above.

The present invention relates generally to a distributed computer environment, multimedia servers and mass merchandising. More particularly, it is a principle object of the present invention to provide a new and improved system and method that facilitates the mass distribution of multimedia on a fee basis using a distributed computer environment and an Internet browser as a universal client to manage the method and system, process the customer request and display the multimedia.

It is further the object of this invention to create a system and method for mass distribution of multimedia that is independent and agnostic of specific computer operating systems and can therefore be utilized in any distributed computer environment.

### BRIEF DESCRIPTION OF THE DRAWINGS

The drawings depict three separate systems and methods that comprise the claimed multimedia distribution system.

FIG. 1 is a diagram illustrating the elements of the cross-platform multimedia distribution system.

FIG. 2 illustrates the three components within the claimed cross platform multimedia distribution system.

FIG. 3 illustrates the basic flow of a request to the cross platform multimedia distribution system.

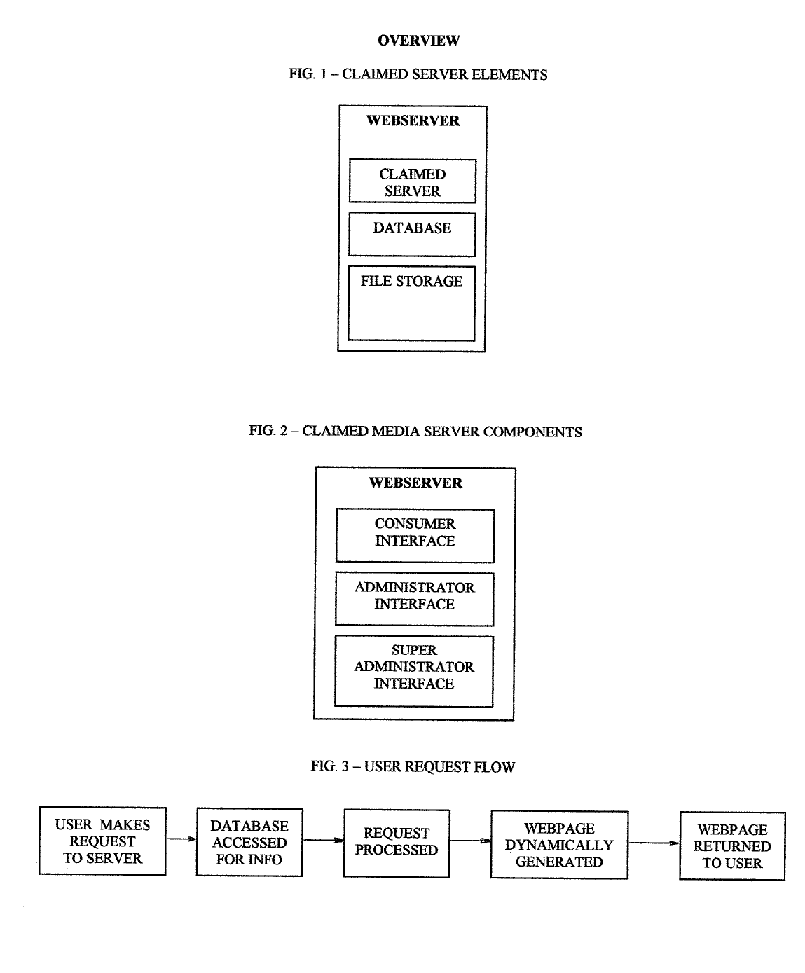

Consumer Interface FIGS. 1 through 10 illustrates how the consumer interface is interleaved in accordance with the invention.

Administrator Interface FIGS. 1 through 9 illustrates how the administrator interface is interleaved in accordance with the invention.

Super Administrator Interface FIGS. 1 though 3 illustrates how the super administrator interface is interleaved in accordance with the invention.

### DETAILED DESCRIPTION OF THE PREFERRED EMBODIMENTS

In one aspect of the invention, a client using a computer connected to a high bandwidth network at a remote location generates a multimedia request to the claimed multimedia distribution system. Upon authentication of the client (the “customer”) by the automated session manager, an automated financial transaction is commenced based upon the price for the multimedia file, set by the administrator (the “Seller”) of the claimed multimedia distribution system. Upon successful completion of the transaction process, the automated session manager generates a web page that contains the multimedia file requested by the customer. The multimedia file includes an embedded system that authenticates the customers licensing prior to opening the multimedia stream port. Upon authentication by the embedded system, the multimedia stream port is opened creating a virtual circuit to connect to the remote customer's computer to the claimed cross platform multimedia system over the high bandwidth network. At the completion of the licensed multimedia session, the session manager then closes the stream port to terminate the connection to the customer over the high bandwidth network.

In another aspect of the invention, the administrator of the claimed cross platform multimedia distribution system manages the operation and functionality of the cross platform multimedia system. The administrator may insert, edit and or/delete multimedia files from the data storage system. Upon insertion, a multimedia files is instantaneously available to all customers accessing the cross platform multimedia server over a high bandwidth network through the automated processes of the session manager. The administrator also controls customer access to multimedia files and may edit, disable or delete individual customers from the claimed cross platform multimedia system.

In another aspect of the invention, the super administrator of the claimed cross platform multimedia system controls all operation and automated functionality of the invention. The super administrator's commands are prioritized by the automated session manager and supersede commands entered by the administrator. The super administrator controls administrator access to the management of the claimed cross platform multimedia system and may disable access or delete administrators.

FIG. 1 illustrates a presently preferred architecture for implementing the cross platform multimedia system over a high bandwidth network. The web server is made of modular units called server elements, which are comprised of the web server hardware, web server operating system, claimed cross platform multimedia system and a data storage system. Each of the web server elements, excluding the claimed cross platform multimedia system, can be fabricated using off-the-shelf computer components and software.

FIG. 2 illustrates the three components within the claimed cross platform multimedia distribution system (the “sub-elements”), which are comprised of a consumer interface, administrator interface and a super administrator interface.

FIG. 3 illustrates the basic flow of a request from a customer to the claimed cross platform multimedia distribution system.

The consumer interface FIG. 1 through FIG. 10 depicts a block diagram illustrating how the consumer interface is interleaved in accordance with the invention. The session manager automatically performs primary authentication of the customer to customize the consumer interface based on customer preference and/or administrator predetermined settings. During the authentication process, the session manager accesses the data storage system (the “database”) for information about the customer's multimedia preferences, multimedia files that meet the customer's preferences and administrator predetermined settings. A webpage is dynamically generated containing the preferred multimedia and displayed over the high bandwidth network on the customers remote terminal. The automated session manager performs this task for every customer that accesses the multimedia distribution system, providing customer specific multimedia presentation for each individual customer.

Once authenticated, a customer may create and/or edit personal account information, payment preferences and multimedia preferences. These actions insert and edit the customer information stored in the database. The customer may also perform a multimedia content search to locate specific types of multimedia files. This action queries the database for multimedia matching the search parameters and dynamically generates a webpage containing the said multimedia. The webpage is then displayed over the high bandwidth network on the customer's remote terminal. The customer may also view specific information about the multimedia. This action produces an additional database query that returns specific information about the multimedia, dynamically generating a webpage for display over the high bandwidth network on the customer's remote terminal.

The customer may then commence a financial transaction to rent or purchase a specific multimedia file. This action queries database for the customer's payment information and the price set by the administrator for the multimedia file. The automated session manager submits this information over a secure network connection to the credit card clearing house for automated authorization. Once the transaction has been authorized by the credit card clearing house, information about the transaction is stored in the database. The automated session manager then verifies the multimedia license and then generates a webpage that either contains an embedded media player and multimedia file or a notification that the license has expired. The webpage is then displayed over the high bandwidth network on the customer's remote terminal. If the customers license is authenticated the automated session manager opens a stream port, creating a virtual circuit and displaying the multimedia within the embedded media player. At the completion of the licensed multimedia session, the automated session manager then closes the stream port to terminate the virtual circuit to the customer over the high bandwidth network.

The entire interface is presented and displayed on the remote customer terminal using an Internet browser. The presentation is manipulated by the customer using a mouse or other pointing device to access hyperlinks within the presentation. The customer moves the pointing device over and selects hyperlinks. Each hyperlink connects the customer to additional embodiments of the claimed multimedia distribution system. Upon customer selection of multimedia licensing, the customer must authorize the commencement of a financial transaction using a keyboard or other device to enter text. Once the financial transaction is authorized and the delivery of the multimedia is authenticated, an additional hyperlink in automatically invoked by the automated session manager that contains an embedded media player, a stream port is opened and multimedia is streamed to the remote customer's terminal over the high bandwidth network.

The administrator interface FIG. 1 through FIG. 9 depicts a block diagram illustrating how the administrator interface is interleaved in accordance with the invention. The session manager authenticates the administrator to authorize access to the administrator interface (the “management console”). During authentication, the session manager accesses the database for information about the administrator and the permission level. On authentication, a webpage is dynamically generated containing hyperlinks to various management tasks and displayed over a secure network connection on the administrators remote or local terminal.

Once authenticated, the administrator may select from specific categories. The administrator may access information about the multimedia files stored within the claimed cross platform multimedia distribution system. This action queries the database and dynamically generates a webpage that contains general information about the multimedia files entered into the claimed cross platform multimedia distribution system and displays the webpage on an Internet browser over the secure network connection. The administrator may then perform various tasks including adding, editing and deleting multimedia files stored within the claimed multimedia distribution system. Each request invokes an individual hyperlink that performs a specific task utilizing the database to return information for viewing, add information or delete information.

The administrator may access information about the users (the “customers”) stored within the claimed cross platform multimedia distribution system. This action queries the database and dynamically generates a webpage that contains general information about the customers using the claimed cross platform multimedia distribution system and displays the webpage on an Internet browser over the secure network connection. The administrator may then perform various tasks including viewing, editing and deleting customer files stored within the claimed multimedia distribution system. Each request invokes an individual hyperlink that performs a specific task utilizing the database to return information for viewing, editing, disabling, reactivating or deleting customers.

The administrator may access information about the sales transactions stored within the claimed cross platform multimedia distribution system. This action queries the database and dynamically generates a webpage that contains general information about multimedia sales transactions using the claimed cross platform multimedia distribution system. The data is formatted and displayed on a webpage using an Interned browser over the secure network connection. The administrator may then edit or delete the transaction information, invoking an individual hyperlink that performs a specific automated task to allow customers to obtain additional access to expired multimedia files (renewing the license) or deleting failed transactions.

The entire interface is presented and displayed on the administrator's terminal using an Internet browser. The presentation is manipulated by the administrator using a mouse or other pointing device to access hyperlinks within the presentation. The administrator moves the pointing device over and selects hyperlinks. Each hyperlink connects the administrator to additional embodiments of the claimed multimedia distribution system.

A secure network connection is not a required embodiment of the claimed multimedia distribution system but is essential to safeguard sensitive information when the administrator accesses the claimed multimedia distribution system from a remote location. A high speed network connection to the management console is not a required embodiment of the claimed multimedia distribution system but is essential if multimedia files are being added from a remote location. The super administrator also has default permission to access the administrator interface.

The super administrator interface FIG. 1 through FIG. 3 depicts a block diagram illustrating how the super administrator interface is interleaved in accordance with the invention. The session manager authenticates the super administrator to authorize access to the super administrator interface (the “management console”). During authentication, the session manager accesses the database for information about the super administrator and the permission level. On authentication, a webpage is dynamically generated containing hyperlinks to various management tasks and displayed over a secure network connection on the super administrators remote or local terminal.

The super administrator may perform various tasks including disabling access to the claimed multimedia distribution system for both the administrator and customers by invoking a hyperlink to commence the automated process. The super administrator may also view various general sales reports and perform automated administrator billing.

The entire interface is presented and displayed on the super administrator's terminal using an Internet browser. The presentation is manipulated by the super administrator using a mouse or other pointing device to access hyperlinks within the presentation. The super administrator moves the pointing device over and selects hyperlinks. Each hyperlink connects the super administrator to additional embodiments of the claimed multimedia distribution system.

What is claimed is:

1. A distributed multimedia client-server system, comprising:
A session manager, in response to receiving a request from a remote client connected to a high bandwidth network, generating a resource allocation request and dynamically creating a multimedia stream port upon client authentication.

2. The system of method of claim 1 further comprising:
A data storage system, storing data about the administration settings, the multimedia, the client and their preferred method of payment, the price of the multimedia; and a data processing system coupled to said data storage system and configured to receive from the client a request to purchase or rent said multimedia from the administrator; to process said request by determining the transaction price for said multimedia based on the price specified by said seller; to output said transaction price forming the basis of a transaction involving said administrator and client.

3. The system and method of claim 1 further comprising:
A method and system for facilitating the financial transaction for the multimedia between the administrator and client prior to multimedia distribution to the client over the high bandwidth network., comprising a data storage system storing data about the client and said client's payment preferences; and a data processing system operatively coupled to said data storage system and configured to process said transaction by querying the said data storage system for the price of the said multimedia and the client's payment information.

4. A client-server media multimedia distribution system according to claim 1 further comprising a method for dynamically wrapping media files to require client authorization and authentication prior to distribution of the multimedia over the high bandwidth network.

5. The system and method of claim 1 further comprising:
multimedia content; means, responsive to commands received by the session manager, for accessing and transporting the multimedia content to the authenticated client via the multimedia stream port; and wherein the multimedia includes stream content, file content and database content.

6. The method in which the system is presented for display at the multimedia server and client terminals.
